(19) United States
(12) Patent Application Publication
(10) Pub. No.: US 2017/0347767 A1
(43) Pub. Date: Dec. 7, 2017

(54) LICE PREVENTIVE HEADBAND

(71) Applicant: Lisa Hudson, East Northport, NY (US)

(72) Inventor: Lisa Hudson, East Northport, NY (US)

(21) Appl. No.: 15/612,058

(22) Filed: Jun. 2, 2017

Related U.S. Application Data
(60) Provisional application No. 62/345,200, filed on Jun. 3, 2016.

(51) Int. Cl. A45D 8/36; A01N 65/08; A01M 29/12; A01N 25/34; A01N 65/44; A01N 65/22

(52) U.S. Cl. CPC A45D 8/36; A01N 65/44; A01N 65/22; A01M 29/12; A01N 25/34; A01N 65/08

(57) ABSTRACT

A non-toxic unitary lice deterring and preventive headband is worn upon the scalp of a wearer. The headband does not use coatings or removable strips, or other reservoirs attached to the headband. The aromatic essential oils are preferably a 1.65% mixture by weight of citronella oil, rosemary oil, lemongrass oil and geranium oil, where the mixture is infused by further admixing in a resin of the styrene butadiene copolymer in an amount of 98.55% by weight. The raw plastic resin material, such as styrene butadiene copolymer, is first premixed and preheated into a malleable, pourable state, which is then admixed with the mixture of aromatic essential oils. The admixture of the plastic resin and aromatic essential oils is then injected into a headband-shaped mold The molded, admixed material is already prepared with lice deterring aromatic essential oils, when the molded, admixed plastic material is molded into a headband shape.

### RELATED APPLICATIONS

This application claims benefit and priority under 35 USC §119 (e) from provisional application Ser. No. 62/345,200 filed Jun. 3, 2016. The '200 application is incorporated by reference herein.

### FIELD OF THE INVENTION

The present invention is a lice preventive headband manufactured by infusing resins with aromatic essential oils and method of use thereof.

### BACKGROUND OF THE INVENTION

Aromatic essential oils are known as a lice preventive, but most prior art headbands have removable felt or other fabric material inserts that are coated with an anti-lice composition, or they are dipped in a solvent and saturated with the essential oils, such as citronella oil, rosemary oil, eucalyptus oil and neem oil, in combination with naturally occurring insect repellents, such as pyrethrum oil.

U.S. Pat. No. 6,936,269 of Robinson discloses an apparatus type headband to which are attached felt bands impregnated with a mixture of wax and pyrethrum oil, optionally with essential oils including citronella oil, rosemary oil, eucalyptus oil and neem oil.

Infused essential oil resin dispersants (i.e. Glade room fresheners) are known, but not for headbands.

Robinson '269 describes anti-lice infestation headbands but not headbands made of resin, which are infused with essential oils in the manufacturing process of the resin itself. Among other related patent references include US Patent Application Publication No. 2014/0000008A1 of Santiago, which discloses stretchable and bendable headbands which are soaked in a lice infestation deterrent solution. However, Santiago '008 does not describe anti-lice infestation headbands made of resins which are infused with essential oils in the resin itself.

WIPO International Publication No. WO/2009/093066A1 Hunt discloses a headband that has attachable straps of absorbent pads which are held in place by a cover.

A pet collar of Bayer® Corporation, sold under the brand name SERESTO®, includes a pet collar for dogs or cats made from a resin infused with Flumethrin and Imidacloprid as active pest reducing and repelling ingredients, as well as other inactive ingredients.

However, the references actually do not teach the use of a lice repelling headband which is made of a resin which is infused with lice repelling aromatic essential oils.

The prior art references of Robinson '269, Santiago '008 and Hunt '066's are concerned with plastic headbands which have attachments, such as felt bands or other strips that are soaked in an anti-lice solution.

These prior art headbands with attachments are unsatisfactory, because they do not have a unitary one-piece headband that emits a controlled odor aroma from a one-piece resin headband infused with lice repelling essential oils.

The multi-piece headbands are complicated to use, which hinder their effectiveness in repelling lice in young wearers, such as children.

### OBJECTS OF THE INVENTION

It is therefore an object of the present invention to provide a unitary one-piece headband that repels lice upon the scalp of the user, without the need for separate soaked or waxed attachment strips of bands that need to be separately attached and/or covered.

It is also an object of the present invention to provide a lice repelling headband which utilizes one or more resins infused with aromatic essential oils and which promotes lice prevention in children's and adult's scalps.

Other objects will become apparent from the following description of the present invention.

### SUMMARY OF THE INVENTION

The present invention is a non-toxic pleasantly aromatic lice preventive headband which is manufactured by infusing resins with aromatic essential oils.

The headband comprises a resin band material which is manufactured while infused with aromatic essential oils which prevent lice infestation. While other resins may be utilized, the resin is preferably a styrene butadiene copolymer, such as KR03 grade copolymer resin of Chevron Phillips Chemical company LP of Woodlands, Tex.

In contrast to the prior art, the headband of the present invention is made from a composition of a resin infused with aromatic essential oils in a mixture, which deters lice, and which does not use coatings or removable strips, or other reservoirs. The aromatic essential oils can be provided in a range of about 1.0% by weight to about 2.0% by weight, preferably about 1.65% by weight, in an admixture by weight of citronella oil, rosemary oil, lemongrass oil and geranium oil, where the admixture is infused, by further mixing, into a resin of styrene butadiene copolymer, wherein the copolymer is provided in an amount of about 98.55% by weight of the total mixture.

In the preferred embodiment, the essential oils are first provided in an admixture including 30% by weight of citronella oil, 30% by weight of rosemary oil, 20% by weight of lemongrass oil, and 20% by weight of geranium oil. It is this admixture of the aforementioned essential oils which is then provided in an amount of about 1.65% by weight of the mixture of the composition forming the resin headband, which also includes the butadiene styrene copolymer in an amount of about 98.55%. by weight of the composition of the mixture.

In an alternate embodiment, the essential oils are selected from the group consisting of citronella oil, rosemary oil, lemongrass oil and/or geranium oil, or in combination. However, in the preferable embodiment, the essential oils include citronella oil, rosemary oil, lemongrass oil and geranium oil, together in combination.

The following steps are used to make the essential oil infused resin, which in turn, is used to make the flexible aromatic lice preventive headband. The raw plastic resin material, such as styrene butadiene copolymer, is premixed and preheated into a malleable, pourable state. The preheated and premixed plastic resin material is then admixed with the mixture of aromatic essential oils. The admixture of the plastic resin and aromatic essential oils is then injected into a headband-shaped mold. The molded, admixed material is already prepared with lice deterring aromatic essential oils, when the molded, admixed plastic material is molded into a headband shape.

Therefore, there is no need for other steps required by the prior art references, such as the separate attachment of other straps or bands to the headband, which are soaked or otherwise formed from wax based processes needed for separate attachment to prior art headbands, after the prior art headband body has been first manufactured by a mold process.

The non-toxic pleasantly aromatic headband of the present invention enhances the repelling of lice in an easily usable headband, by incorporating the admixed aromatic essential oils into the plastic resin before the resin is put in the headband-shaped mold. The addition of the infused aromatic essential oils to the resin greatly enhances the controlled release of the aromatic essential oils aroma aspects while maintaining its utility as a lice preventive headband.

The use of butadiene styrene copolymer, such as KR03 polymer of Chevron Phillips Chemical Company LP of Woodlands, Tex., provides the headband with stability and a controlled aroma release which repels and deters lice.

The important lice repelling function of the essential oil infused resin headband is maintained with this feature. The synergistic combination of the infused aromatic essential oils with the resin copolymer provides beneficial effects that are not possible with any other type of lice preventive headband.

Applicant has had tests of the efficacy of the subject matter of the invention. A confidential study was performed and reported in April 2016 of in vitro tests of the efficacy of the subject matter on lice, during a study of controlled exposure of strips of Applicant's resin hairband infused with essential oil on the actual lice insects. The findings of the Case Study showed a 92% effectiveness of the preferred embodiment noted above of the subject matter of the present invention in repelling lice away from the Applicant's mixture.

The study was entitled “A PROOF OF CONCEPT STUDY TO COMPARE THE EFFICACY OF SPICE FOR LIFE HEADBANDS INFUSED WITH NATURAL OILS TO DETER HEAD LICE WHEN COMPARED TO UNPROTECTED HUMAN HAIR”, by Katie Shepherd of LSRN Research of West Palm Beach, Fla., 33407, 21 pages, April, 2016. The study is attached hereto as an Appendix to the specification herein.

The study tested Applicant's preferred embodiment, which included the aforementioned KR03 resin (a butadiene styrene copolymer) infused with the admixed combination of essential oils provided in an essential oil admixture of 30% by weight of citronella oil, 30% by weight of rosemary oil, 20% by weight of lemongrass oil, and 20% by weight of geranium oil. The essential oils were provided in an amount of 1.65% by weight of the mixture, and the KR03 resin was provided at 98.55% by weight of the mixture.

The Conclusions of the Study noted as follows:

Results derived from this “in vitro” study proved that, for the most part, Spice for Lice headbands infused in natural oils did have a desirable repelling effect in protecting hair from head lice. Based on the results of this “in vitro” study, the Spice for Lice headbands could prove to be an effective tool for parents considering lice prevention products and as a result further product testing in a clinical environment would be justified.”

### BRIEF DESCRIPTION OF THE DRAWINGS

The present invention can best be understood in connection with the accompanying drawings. It is noted that the invention is not limited to the precise embodiments shown in drawings, in which:

FIG. 1 is a flow chart of the method of making and using the unitary lice preventive and deterring headband of the present invention;

FIG. 2 is a perspective view of the unitary lice preventive and deterring headband of the present invention;

FIG. 3 is a front elevational view of the unitary lice preventive and deterring headband of the present invention;

FIG. 4A is an inside view in partial crossection of the left side portion and crown of the unitary lice preventive and deterring headband of the present invention, taken along view lines “4A-4A” of FIG. 3, and showing in cross hatching in the cutaway area “E”, the aromatic essential oil infused resin material;

FIG. 4B is an exterior left side view of the left side portion and crown of the unitary lice preventive and deterring headband of the present invention;

FIG. 4C is a close-up detail view of a portion of the right side portion and crown of the unitary lice preventive and deterring headband, taken along view circle line “4C” of FIG. 3;

FIG. 4D is a close-up detail view in crossection cutaway view of one of the nibs attached to the inside surface of the right side portion of the unitary lice preventive and deterring headband; taken along view line “4D-4D” of FIG. 4C, wherein further in FIG. 4D, the small circles or bubbles, which are shown within the cross sectional view of the plastic resin material depicted therein, diagrammatically indicate the essential oils ingredient contained within the plastic resin structure of the headband.

FIG. 5 is a perspective view of the unitary lice preventive and deterring headband of the present invention, shown being worn upon the head of a child.

### DETAILED DESCRIPTION OF THE INVENTION

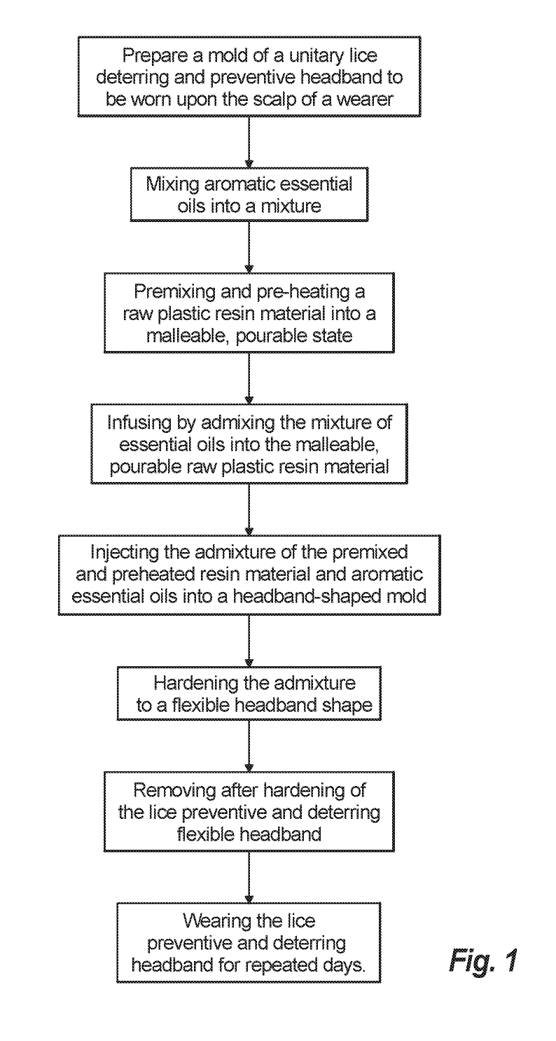

FIG. 1 is a flow chart of the method of making and using the non-toxic pleasantly aromatic, unitary, flexible lice preventive and deterring headband 1 of the present invention. For example, the following steps are used to make the essential oil infused resin, which in turn, is used to make the flexible aromatic lice preventive headband 1. The raw plastic resin material, such as styrene butadiene copolymer, is premixed and preheated into a malleable, pourable state. The preheated and premixed plastic resin material is then admixed with the mixture of aromatic essential oils. The admixture of the plastic resin and aromatic essential oils is then injected into a headband-shaped mold. The molded, admixed material is already prepared with lice deterring aromatic essential oils, when the molded, admixed plastic material is molded into a headband shape of unitary, flexible headband 1.

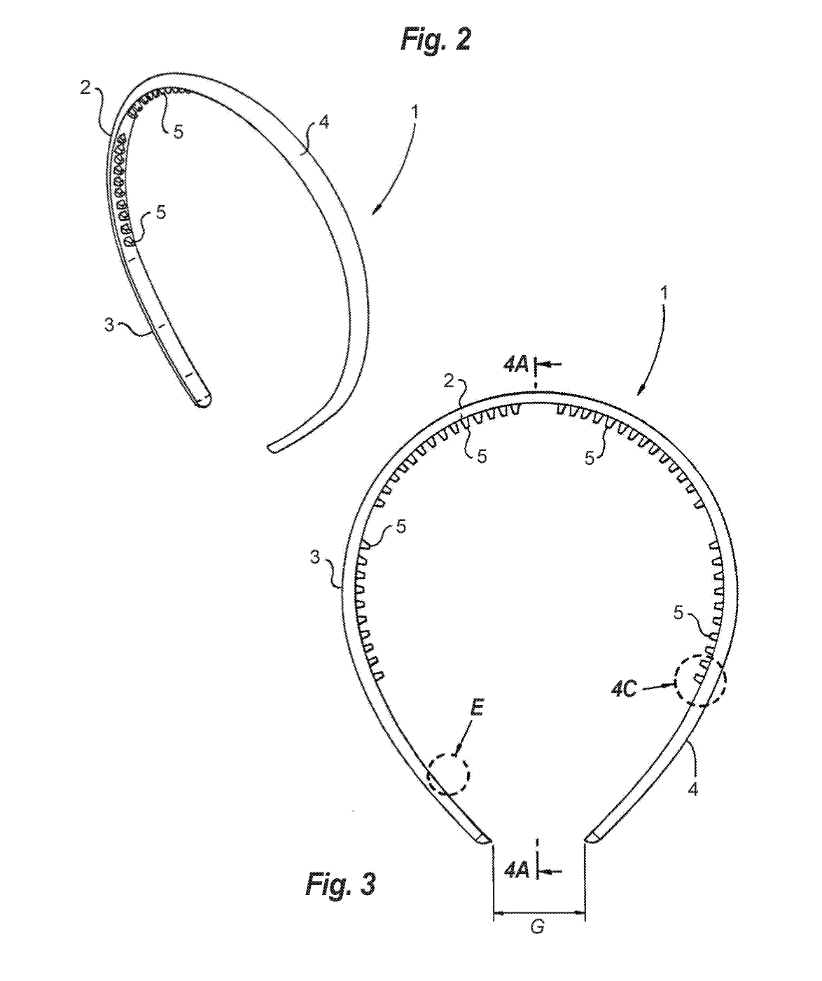

FIG. 2 shows unitary flexible headband 1 with top rounded crown portion 2 and two descending curved side portions 3 and 4, separated by a gap “G”. An inside of the crown and upper portions of the left side portion 3 and right side portion 4 of the headband 1 each include sets of arrays of nibs 5, for comfort and to stabilize the headband 1 upon the scalp of the user. The flexible headband 1 has a bendable modulus of elasticity known to those skilled in the art of making headbands, so that the gap “G” of the headband 1 can be opened for insertion over the scalp of the wearer, and then bend back to grasp the scalp of the user.

The shape of the headband when viewed from the front, as in FIG. 3, is that of truncated teardrop shape, where the open bottom gap G provides a recess that is expandable in size, while the sides 3 and 4 are bendable outward, and then retractable inward, when the user dons the headband 1 upon the scalp of the user.

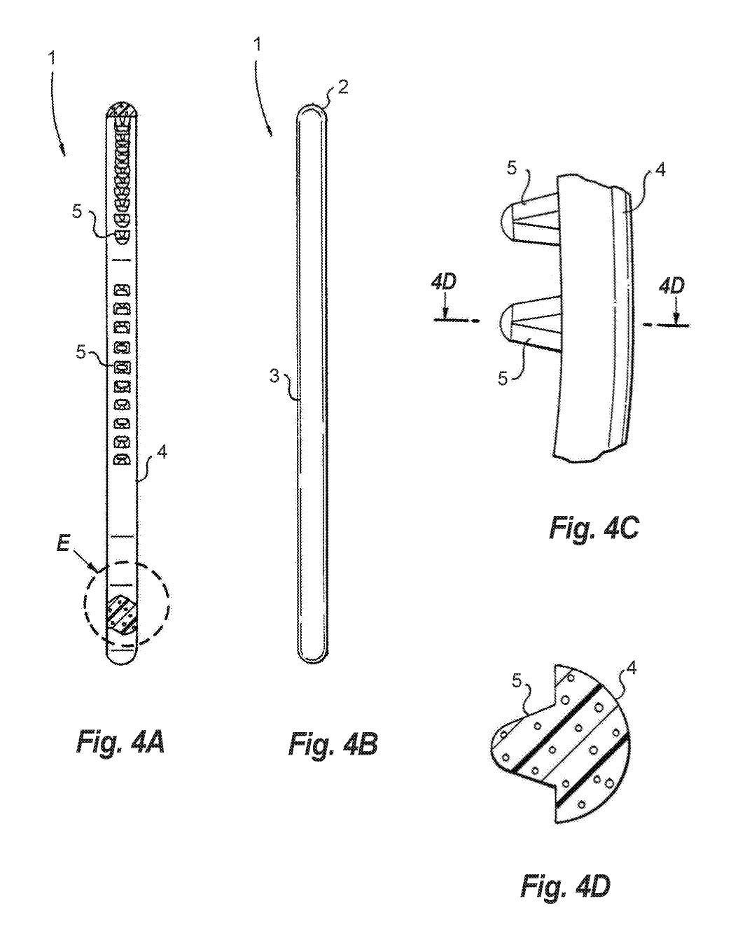

FIG. 3 shows a front elevational view of the unitary lice preventive and deterring headband 1 with crown 2 and flexible descending curved side portions 3 and 4, each having nibs 5 extending in respective arrays thereon. The nibs are small rounded top conical shaped protrusions, extending inward from the inside surfaces of the crown 2, left side portion 3 and right side portion 4 of the headband 1. Although size may vary depending upon the size of the head of the user, as shown in FIG. 3, the truncated, open recessed teardrop shaped headband 1 is preferably about 5.045 inches in height and 4.455 inches in width. As shown in FIG. 4B, the headband 1 is about 0.265 inches in depth. As shown in FIG. 4C and FIG. 4D, each nib is about 0.101 inch in height and 0.133 inches in width, and wherein the central axis of each nib 5 is separated from the central axis of adjacent nibs 5 by a distance of about 0.168 inches apart from each other. The conical shaped nibs 5 have a rounded top with a radius of about 0.031 inches radius. Additionally, the outer edges of headband 1 are convex, with a radius of about 0.133 inches radius. FIG. 3 also shows cutout area “E” on the left side of headband 1, and as shown in the lower region “E” of FIG. 4A.

FIG. 4A shows an inside view in partial crossection of the left side portion 4 with nibs 5, of the unitary lice preventive and deterring headband 1 of the present invention, taken along view lines “4A-4A” of FIG. 3, and showing in cross hatching in the cutaway area “E”, of the aromatic essential oil infused resin material;

FIG. 4B shows an exterior left side portion 3 and left side of upper crown 2 of the unitary lice preventive and deterring headband 1.

FIG. 4C is a close-up detail view showing nibs 5 extending up from a small portion of the right side portion 4 of the unitary lice preventive and deterring headband 1, taken along view circle line “4C” of FIG. 3;

FIG. 4D is a close-up detail view in crossection cutaway view of one of the nibs 5 attached to the inside surface of the right side portion 4 of the unitary lice preventive and deterring headband 1, taken along view line “4D-4D” of FIG. 4C. In FIG. 4D, the small circles or bubbles, which arc shown within the cross sectional view of the plastic resin material depicted therein, diagrammatically indicate the essential oils ingredient contained within the plastic resin structure of the headband 1.

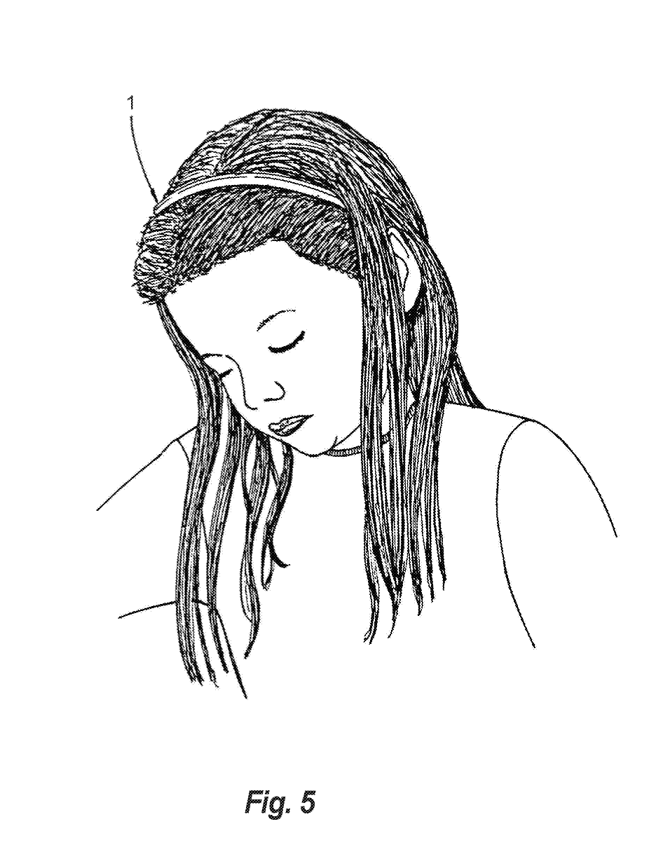

FIG. 5 shows the unitary, flexible lice preventive and deterring headband 1 being worn upon the head of a child.

When worn, the non-toxic unitary, flexible headband 1 emits the aromatic odors of the admixed essential oils, such as, for example, citronella oil, rosemary oil, lemongrass oil and geranium oil, which emit the odors deterring lice infestation, daily, for a period of weeks, up to six months' time of use duration, when the unitary flexible headband is replaced, if necessary to prevent further lice infestation. The headband is worn for certain portions of the day, such as, for example, during school or day care hours, when the wearer may come in contact with other persons or children having lice in their hair, or during eight hours of sleep, if there is a possibility of lice infestation at home. When not worn, the headband then is stored in a closable, lockable bag until used the next day, to prevent the escape of odors when not worn upon the head of the wearer.

For illustrative purposes only, a preferred mode for carrying out the invention is described herein, wherein a headband is made of a resin, such as, for example, among related copolymers, is butadiene styrene copolymer KR03 of Chevron Philips Company, Inc., such as shown in the following Table I.

The KR03 butadiene styrene copolymer is infused by admixing the copolymer resin with a mixture of aromatic essential oils, such as citronella oil, rosemary oil, lemongrass oil and geranium oil, when the resin is heated and made malleable for pouring into a headband shaped mold.

TABLE 1
KR03
The KR03 copolymer is a copolymer of K-Resin ® Styrene-
Butadiene Copolymers (SBC) of Chevron Philips Company, Inc.

| Nominal | Con- | | | |
|---|---|---|---|---|
| Physical Properties | dition | English | SI | Method |
| Specific Gravity | — | 1.01 g/cc | 1.01 g/cc | ASTM |
| | | | | D792 |
| Melt Flow Rate | 200° C./ | 7.5 g/ | 7.5 g/ | ASTM |
| | 5 Kg | 10 min | 10 min | 1238 |
| Tensile Yield | 2.0 in/ | 3800 psi | 26 MPa | ASTM |
| Strength ⁽²⁾ | min | | | D638 |
| Tensile Elongation @, | 2.0 in/ | 230% | 230% | ASTM |
| Break ⁽²⁾ | min | | | D638 |
| Flexural Modulus ⁽³⁾ | 0.5 in/ | 260,350 | 1795 | ASTM |
| | min | psi | Mpa | D790 |
| Flexural Yield | 0.5 in/ | 5400 psi | 37 Mpa | ASTM |
| Strength ⁽³⁾ | min | | | D790 |
| Deflection Temperature | 264 psi | 144° F. | 62° C. | ASTM |
| Under Load (DTUL) | (1.8 MPa) | | | D648 |
| Instrumental Impact | 73° F. | 354 | 40 J | ASTM |
| Total Energy ⁽⁴⁾ | | in-lbs | | D3763 |
| Hardness, Shore D | — | 63 | 63 | ASTM |
| | | | | D2240 |
| Vicat Softening Point | — | 185° F. | 85° C. | ASTM |
| | | | | D1525 |
| Gardner | 60° | 162% | 162% | ASTM |
| Gloss _{(Mold Temperature 100° F.)} | | | | D2457 |
| Light Transmission | — | 92% | 92% | ASTM |
| | | | | D1003 |
| Moisture Absorption | 24 h | 0.09% | 0.09% | ASTM |
| | | | | D570 |

1. The nominal properties herein are typical of the product but do not reflect normal testing variance and therefore should not be used for specification purposes. Values are rounded.
² Type 1 @ 2 in/min (50 mm/min)
³ 0.125 in (3.2 mm) specimen @ 0.5 in/sec (1.27 cm/min)
⁴ 0.125 in (3.2 mm) specimen @ 150 in/sec (381 cm/sec) impact rate

Meets these Important Requirements:
K-Resin® SBC grade KR03, as shipped by Chevron Phillips Chemical Company LP, meets the specifications of the United States FDA Food Packaging Regulation 21 CFR 177.1640 (polystyrene and rubber modified polystyrene). By virtue of this compliance, K-Resin® KR03 may be used as a component of articles for use in contact with food. There are no regulatory food type or temperature restrictions on this resin as defined under 21 CFR 176.170(c).
Commission Regulation (EU) No. 10/2011 and all its amendments.
USP Class VI
UL 94HB
K-Resin® SBC grade KR03 is produced in an ISO 9001-2008 certified plant.
   The aforementioned Table I is contained in MSDS 100000000061 of Chevron Philips Company Inc, as revised in February 2012.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A method of making and using a non-toxic, pleasantly aromatic, unitary, flexible lice preventive and deterring headband made of essential oils infused resin, comprising the steps of:
providing a raw plastic resin material;
premixing and preheating said raw plastic resin material into a malleable, pourable stat;
admixing said preheated and premixed plastic resin material with a mixture of aromatic essential oils;
injecting said admixture of plastic resin and aromatic essential oils into a headband-shaped mold; wherein said molded, admixed plastic material is molded into a headband shape of a unitary, flexible headband capable of emitting aromas of said aromatic essential oils for a pre-determined period of time when worn upon the scalp and hair of a user;
said headband having lice deterring properties, whereby a user of said headband has some protection from lice.

2. The method as in claim 1 wherein said raw plastic resin material is a styrene butadiene copolymer,

3. The method as in claim 2 wherein said mixture of aromatic essential oils is provided at about 1.65% by weight of the total composition of said admixture and said butadiene styrene copolymer is provided at about 98.55% by weight of the total composition of said admixture.

4. The method of claim 36 in which said aromatic essential oil is selected from the group consisting of citronella oil, rosemary oil, lemongrass oil, and geranium oil, which emit odors deterring lice infestation.

5. The device of claim 4 in which said aromatic essential oil is an admixture of citronella oil, rosemary oil, lemongrass oil, and geranium oil.

6. The device of claim 5 in which said admixture consists of about 30% by weight of citronella oil, 30% by weight of rosemary oil, 20% by weight of lemongrass oil, and 20% by weight of geranium oil.

7. The method of making a lice preventive and deterring headband as in claim 1 further comprising the steps of:
providing said headband with a crown portion and a pair of descending curved side portions separated by a gap between distal ends of said side portions, an outer surface of said crown portion and descending side portions being rounded, an inner surface of said crown portion and descending side portions being uncurved from one side edge to an opposite side edge;
forming on the inside surface of the crown and upper parts of said side portions an array of spaced nibs for comfort and to stabilize the headband on a scalp of a user;
said flexible headband having a bendable modulus of elasticity such that said gap may be opened for insertion over the scalp of the user, and then bent back to grasp said scalp

8. The method of claim 7 in which each of said nibs is conically shaped with a curved distal end.

9. A lice preventive and deterring device comprising:
a unitary one-piece elongate member molded into a shape of a flexible headband;
said headband being formed with a mixture of aromatic essential oils infused with a resin material having lice deterring properties.
said headband having a crown portion and a pair of descending curved side portions separated by a gap between distal ends of said side portions;
an outer surface of said crown portion and descending side portions being rounded;
an inner surface of said crown portion and descending side portions being uncurved from one side edge to an opposite side edge;
the inside surface of the crown and upper parts of said side portions having an array of spaced nibs for comfort and to stabilize the headband on a scalp of a user; and,
said flexible headband having a bendable modulus of elasticity such that said gap may be opened for insertion over the scalp of the user, and then bent back to grasp said scalp

10. The device of claim 9 in which each of said nibs is conically shaped with a curved distal end.

11. The device of claim 9 in which said aromatic essential oil is selected from the group consisting of citronella oil, rosemary oil, lemongrass oil, and geranium oil, which emit odors deterring lice infestation.

12. The device of claim 9 in which said aromatic essential oil is an admixture of citronella oil, rosemary oil, lemongrass oil, and geranium oil.

13. The device of claim 12 in which said admixture consists of about 30% by weight of citronella oil, 30% by weight of rosemary oil, 20% by weight of lemongrass oil, and 20% by weight of geranium oil.

14. The device of claim 9 in which said resin is a styrene butadiene copolymer.
